(19) United States
(12) Patent Application Publication
(10) Pub. No.: US 2014/0039878 A1
(43) Pub. Date: Feb. 6, 2014

(54) Symbolic-To-Natural Language Conversion

(71) Applicant: Apollo Group, Inc., Phoenix, AZ (US)

(72) Inventor: Michael Wasson, Pittsburgh, PA (US)

(73) Assignee: Apollo Group, Inc., Phoenix, AZ (US)

(21) Appl. No.: 13/903,093

(22) Filed: May 28, 2013

Related U.S. Application Data
(60) Provisional application No. 61/678,602, filed on Aug. 1, 2012.

(51) Int. Cl. G06F 17/28

(52) U.S. Cl. CPC G06F 17/28
USPC 704/9

(57) ABSTRACT

Techniques are described for converting characters that represent a mathematical expression, according to mathematical conventions, into natural language that communicates the mathematical expression based on the rules of the natural language for communicating mathematical expressions. A mathematical expression parser parses the characters representing the mathematical expression into a syntax tree. A visitor function visits each node of the syntax tree and produces natural language for the nodes based, at least in part, on types of the syntax tree nodes and, potentially, contexts of syntax tree nodes. The natural language produced for the syntax tree is assembled into a string based, at least in part, on the structure of the syntax tree. The resulting natural language string may be displayed via a graphical user interface, used by a text-to-speech mechanism to produce a spoken communication of the natural language for the mathematical expression, etc.

### BENEFIT CLAIM

This application claims the benefit of Provisional Appln. No. 61/678,602, filed Aug. 1, 2012, the entire contents of which is hereby incorporated by reference as if fully set forth herein, under 35 U.S.C. §119(e).

### FIELD OF THE INVENTION

The present invention relates to creating natural language that represents mathematical expressions, and, more specifically, to converting characters that represent a mathematical expression into a natural language string that conforms to the rules of the natural language for communicating mathematical expressions.

### BACKGROUND

Many times, it is advantageous to convert mathematical expressions that are expressed using mathematical conventions into natural language. Mathematical conventions are rules for arranging symbols to communicate mathematical concepts. For example, FIG. 1 illustrates two mathematical expressions 100 and 110 that are expressed using two different sets, respectively, of mathematical conventions. A person that is familiar with mathematical conventions would be able to properly interpret the mathematical concepts that are communicated through mathematical expressions constructed using mathematical conventions (such as mathematical expressions 100 and 110). Technologies, such as MathML, facilitate displaying mathematical expressions on web pages where the mathematical expressions are expressed using mathematical conventions.

Some users may find natural language that represents a mathematical expression more helpful than a display of the mathematical expression using mathematical conventions. Natural languages are generally spoken languages (such as American English), many of which have rules for verbally communicating mathematical expressions. Being able to read or hear natural language that represents a mathematical expression may be helpful, for example, for a user that is vision-impaired, or for a user that has a reading impairment such as dyslexia.

Math-to-speech technologies, such as Math Player by Design Sciences, generally convert each character, in turn, of a mathematical expression that is represented using mathematical conventions into the natural language version of that character. For example, a math-to-speech technology may convert the mathematical expression “(8+3)/3” to the natural language string “open parenthesis eight plus three close parenthesis divided by three”.

However, converting each character of a mathematical expression representation into the natural language version of the character is not generally how a native speaker of a natural language (who understands mathematics) would convert a mathematical expression into the natural language. Such a character-by-character recitation of a mathematical expression does not generally conform to the rules of a natural language for communicating mathematical expressions, which may cause the results to be confusing to a speaker of the natural language. One example string that represents the mathematical expression “(8+3)/3” in natural language that conforms to the rules of American English for communicating mathematical expressions is: “the quantity eight plus three all over three”.

It would be advantageous to provide a mechanism that produces natural language, for mathematical expressions, that conforms to the rules of the natural language for communicating mathematical expressions.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 depicts mathematical expressions that are expressed using mathematical conventions.

FIG. 2 is a block diagram that depicts an example network arrangement for creating natural language that communicates mathematical expressions based on the rules of the natural language for communicating mathematical expressions.

FIG. 3 depicts a graphical user interface.

FIG. 4 depicts a flowchart for converting displayed mathematical expressions to natural language.

FIG. 5 depicts a syntax tree that represents the content and structure of a mathematical expression.

FIGS. 6A-6B depict a non-limiting example of constructing a natural language text string to represent a particular mathematical expression.

FIG. 7 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Characters representing a mathematical expression, according to mathematical conventions, are converted into natural language that communicates the mathematical expression according to the rules of the natural language for communicating mathematical expressions. American English is used as the example natural language hereafter, but embodiments are not restricted to American English. Embodiments may be implemented in Spanish, French, or any other natural language, based on the respective rules for communicating mathematical expressions in that language.

A mathematical expression parser parses the characters representing the mathematical expression into a syntax tree. A visitor function visits each node of the syntax tree and produces natural language for the nodes based, at least in part, on types of the syntax tree nodes and, potentially, contexts of the syntax tree nodes. The natural language produced for the nodes of the syntax tree is assembled into a string based, at least in part, on the structure of the syntax tree. The resulting natural language string may be displayed via a graphical user interface, used by a text-to-speech mechanism to produce a spoken version of the natural language for the mathematical expression, etc.

### Mathematical Expression Converter Architecture

Techniques are described hereafter for creating natural language that communicates mathematical expressions based on the rules of the natural language for communicating mathematical expressions. According to embodiments, a math converter client on a client device causes a mathematical expression, displayed at a display device associated with the client device, to be converted into natural language. A math converter service receives information for the mathematical expression from the math converter client, processes the received information, and returns natural language, to the math converter client, that represents the mathematical expression.

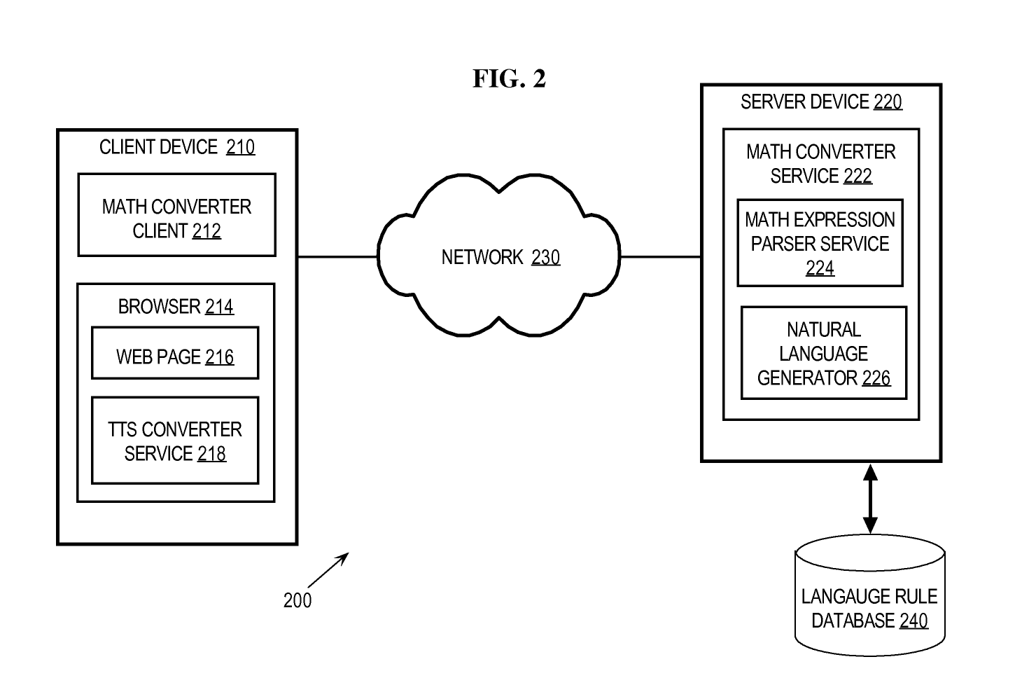

FIG. 2 is a block diagram that depicts an example network arrangement 200 for creating natural language that communicates mathematical expressions based on the rules of the natural language for communicating mathematical expressions, according to embodiments. Network arrangement 200 includes a client device 210, and a server device 220 communicatively coupled via a network 230. Server device 220 is also communicatively coupled to a language rule database 240. A network arrangement for creating natural language, according to embodiments, may include other devices, such as client devices, server devices, and display devices (not depicted in FIG. 2). For example, one or more of the services attributed to server device 220 herein may run on other server devices that are communicatively coupled to network 230.

Client device 210 may be implemented by any type of computing device that is communicatively connected to network 230. Example implementations of client device 210 include, without limitation, workstations, personal computers, laptop computers, personal digital assistants (PDAs), tablet computers, cellular telephony devices (such as smart phones), televisions, and any other type of computing device.

In network arrangement 200, client device 210 is configured with a math converter client 212 and a browser 214 that displays web page 216. Browser 214 is further configured with a text-to-speech (TTS) converter service 218, e.g., as a plug-in to browser 214. According to another embodiment, TTS converter service 218 runs on client device 210 as a stand-alone application that is independent from browser 214. According to yet another embodiment, TTS converter service 218 runs on a server device, such as server device 220, that is accessible by client device 210 via network 230.

Math converter client 212 may be implemented in any number of ways, including as a plug-in to browser 214, as an application running in connection with web page 216, as a stand-alone application running on client device 210, etc. Browser 214 is configured to interpret and display web pages received over network 230, such as Hyper Text Markup Language (HTML) pages, and eXtensible Markup Language (XML) pages, etc. Client device 210 may be configured with other mechanisms, processes, and functionalities, depending upon a particular implementation.

Furthermore, client device 210 is communicatively coupled to a display device (not shown in FIG. 2), for displaying graphical user interfaces (e.g., of web page 216). Such a display device may be implemented by any type of device capable of displaying a graphical user interface. Example implementations of a display device include a monitor, a screen, a touch screen, a projector, a light display, a display integrated with a tablet computer, a display integrated with a telephony device, a television, etc.

Network 230 may be implemented with any type of medium and/or mechanism that facilitates the exchange of information between client device 210 and server device 220. Furthermore, network 230 may use any type of communications protocol, and may be secured or unsecured, depending upon the requirements of a particular embodiment.

Server device 220 may be implemented by any type of computing device that is capable of communicating with client device 210 over network 230. In network arrangement 200, server device 220 is configured with a math converter service 222 that includes a math expression parser service 224, and a natural language generator (NLG) 226. According to embodiments, one or more of services 222-226 may be part of a cloud computing service.

Any of services 222-226 may receive and respond to Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication, e.g., from math converter client 212 or from one of the other services 222-226. Further, any of services 222-226 may send one or more of the following over network 230 to math converter client 212 or to one of the other services 222-226: information via HTTP, HTTPS, SMTP, etc.; XML data; SOAP messages; API calls; and other communications according to embodiments. Services 222-226 may be implemented by one or more logical modules, and are described in further detail below. Server device 220 may be configured with other mechanisms, processes and functionalities, depending upon a particular implementation.

Server device 220 is communicatively coupled to language rule database 240. Language rule database 240 may reside in any type of storage, including volatile and/or non-volatile storage including random access memory (RAM), one or more hard or floppy disks, or main memory. The storage on which language rule database 240 resides may be external or internal to server device 220.

In one embodiment, language rule database 240 stores information for natural language rules that NLG 226 uses to convert mathematical expressions into natural language strings. The appendix to this document, “Appendix A”, includes example natural language rules that may be stored at language rule database 240. The rules in Appendix A are exemplary and non-limiting within embodiments.

### Mathematical Expressions

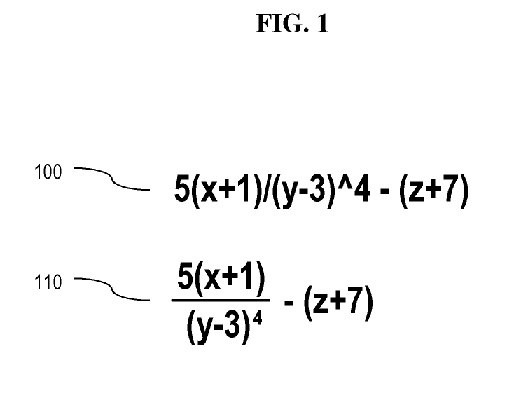

A mathematical expression is a combination of numbers, quantities, variables, operands, and/or other mathematical constructs, all of which are well-defined by mathematical conventions to communicate the mathematical concepts. A displayed mathematical expression is communicated using written notation. For example, a mathematical expression may include ASCII characters that are arranged according to mathematical conventions. FIG. 1 includes two alternate depictions (using two different mathematical conventions, respectively) of the same mathematical expression: mathematical expression 100 and mathematical expression 110. Within embodiments, a mathematical expression may be displayed in a web page (such as an HTML or XML file), a pdf document, a text document, an image, etc.

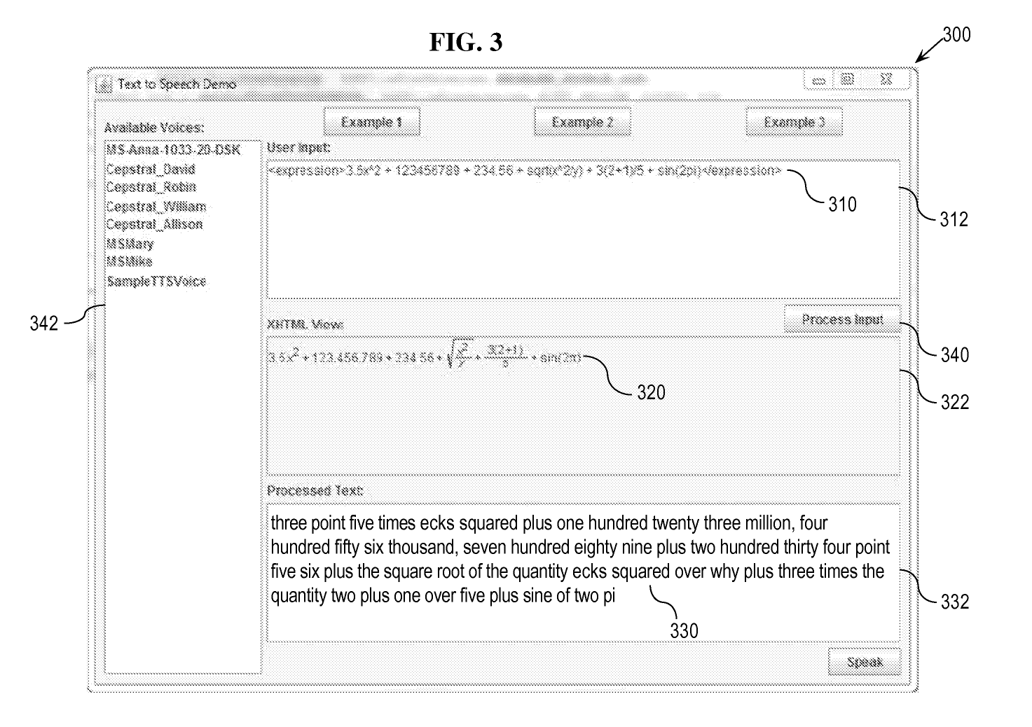

As a further example of representations of mathematical expressions, FIG. 3 depicts a graphical user interface (GUI) 300 that, according to an embodiment, is displayed in the context of web page 216 of FIG. 2. GUI 300 includes two alternate depictions of a particular mathematical expression within a GUI 300: user input expression 310 and XHTML view expression 320. GUI 300 includes a user-editable field 312 that displays user input expression 310. GUI 300 also includes a field 322 that displays XHTML view expression 320. The mathematical expression 320 displayed at field 322 is the same mathematical expression as is represented in field 312, but expression 320 is displayed using a different mathematical convention than the convention used for expression 310.

The mathematical convention used to display expression 320 allows for a structured mathematical representation, which is not amenable to being displayed as ASCII text, but which may be displayed, e.g., as an image or set of images, using special mathematical characters, etc. The mathematical convention, comprising ASCII characters, that is used to communicate a mathematical expression that is typed into an input field (e.g., expression 310 in field 312) can be more difficult to understand than the more aesthetically appealing mathematical convention used to display expression 320 in field 322, which results in a structured mathematical representation. Fields 332, 342, and output text 330 are described below. As is evident by expressions 310 and 320, different mathematical conventions may comprise some of the same notations.

According to an embodiment, a user may identify the portion of a string that communicates a mathematical expression, in the context of a string that includes both mathematical expression and other kind of expression, with delineating tags just before the beginning of the mathematical expression string and just after the end of the mathematical expression string. In this embodiment, math converter client 212 uses the delineating tags to identify the beginning and end of the portion of the string that represents the mathematical expression. According to this embodiment, math converter client 212 only invokes math converter service 222 to create natural language for text within delineating tags, e.g., the open and close “<expression> . . . </expression>” tags depicted in expression 310 of FIG. 3. Other delineating tag examples are: “<span class=“expression”> . . . </span>”, “:: . . . ::”, etc. Such delineating tags would not end up in the natural language string produced by math converter service 222. According to another embodiment, math converter client 212 identifies the entire string input into a particular field as mathematical expression.

### Converting a Mathematical Expression to Natural Language

To convert a mathematical expression to natural language, math converter client 212 detects a mathematical expression to be converted to natural language, e.g., by a user activating a process input button 340 of GUI 300, which causes math converter client to identify a mathematical expression within field 312. Math converter client 212 may identify or detect a mathematical expression to be converted to natural language in any number of ways within embodiments.

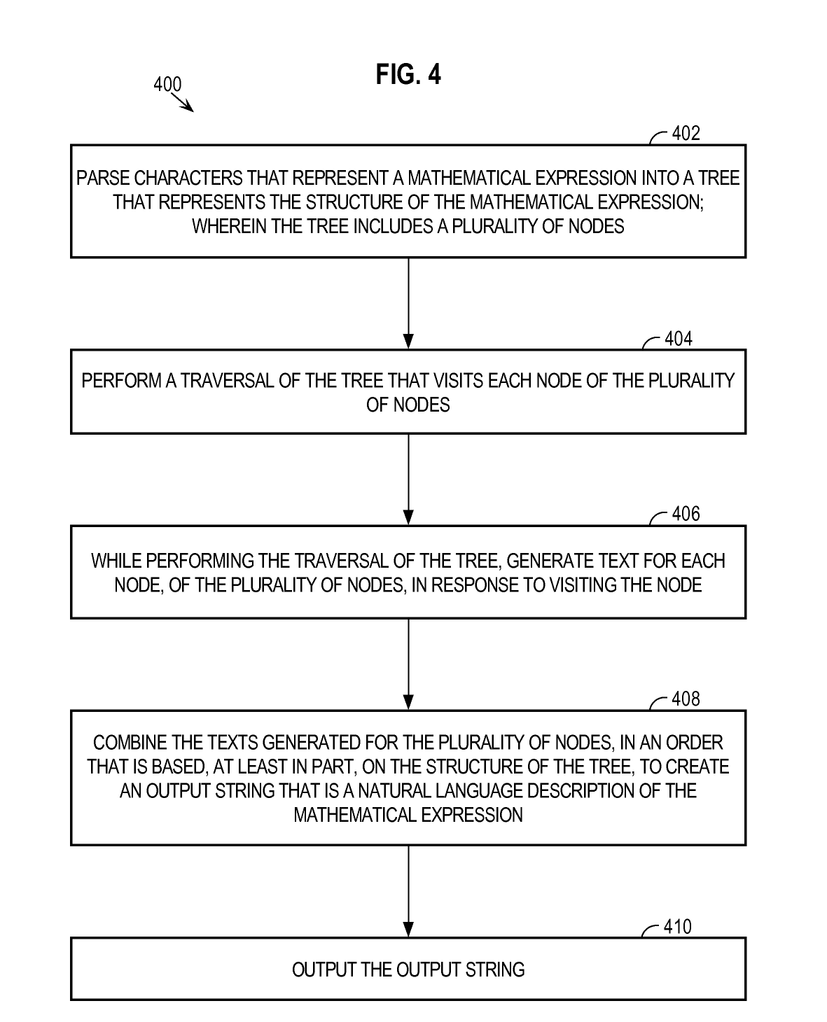

Math converter client 212 sends information for the detected mathematical expression to math converter service 222. Math expression parser service 224 parses the characters representing the mathematical expression, in the received information, into an abstract syntax tree. The resulting abstract syntax tree represents the content and structure of the parsed mathematical expression. NLG 226 converts the abstract syntax tree into natural language by traversing the tree and generating natural language for nodes of the tree based, at least in part, on types of the nodes and, potentially, contexts of the respective nodes. NLG 226 uses a set of rules that take into account the type of a syntax tree node and, at times, a context of a syntax tree node to produce the natural language for that node. FIG. 4 depicts a flowchart 400 for converting displayed mathematical expressions to natural language.

### Parsing a Mathematical Expression into an Abstract Syntax Tree

At step 402, characters that represent a mathematical expression are parsed into a tree that represents the structure of the mathematical expression, where the resulting tree includes a plurality of nodes.

For example, math converter client 212 receives information for mathematical expression 100 of FIG. 1, e.g., as ASCII characters via field 312 of FIG. 3. Math converter client 212 transmits information for expression 100 to math converter service 222 of server device 220. Math expression parser service 224, of math converter service 222, parses characters that represent expression 100—from the information for expression 100—into a tree that represents the content and structure of expression 100. (See http://en.wikipedia.org/wiki/Abstract_syntax_tree, which is incorporated herein by reference, for more information about abstract syntax trees.)

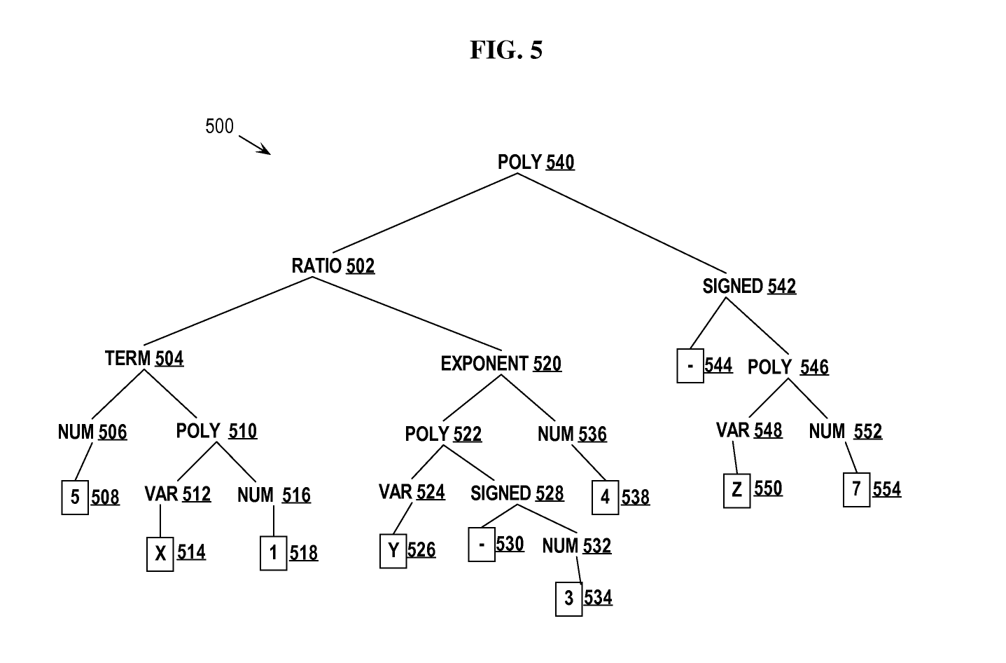

To illustrate, FIG. 5 depicts a syntax tree 500 that is an example of a syntax tree that represents the content and structure of mathematical expression 100. Other syntax trees may also represent the content and structure of mathematical expression 100 within embodiments. For example, in another implementation of a syntax tree for mathematical expression 100, node 528 is a NumberExpression node with a child node that represents “−1”. (See Table 1.) As a further example, in yet another implementation of a syntax tree for mathematical expression 100, node 528 is a NegativeExpression node with a child that represents “1”.

### Converting a Syntax Tree to Natural Language Text

At step 404 of flowchart 400 (FIG. 4), a traversal of the tree is performed, which traversal visits each node of the plurality of nodes. For example, NLG 226 uses a visitor pattern to perform functions for the nodes of syntax tree 500. (See en.wikipedia.org/wiki/Visitor_pattern, which is incorporated herein by reference, for more information about a visitor pattern.)

At step 406, while traversal of the tree is being performed, text is generated for each node, of the plurality of nodes, in response to visiting the node. For example, the function that NLG 226 performs for a particular node of tree 500 produces natural language text that represents the particular node. The natural language text produced for a tree node describes the portion of the mathematical expression that corresponds to the node, and is based, at least in part, on a type of the node. Furthermore, the text produced for a particular node of a tree may also be based, at least in part, on a context of the particular node.

Table 1, below, includes example node types for syntax tree nodes, with corresponding short names (as utilized in syntax tree 500 of FIG. 5) and intuitive mathematical meanings of the node types. The node types listed in Table 1 are non-limiting examples; many different node types may be used within embodiments.

TABLE 1
Example Syntax Tree Node Types

| Node Type | Short Name | Intuitive Mathematical Meaning |
|---|---|---|
| AbsoluteValueExpression(x) | ABS | \|x\| |
| DivisionSymbol(a, b) | DIV | a divided by b (inline division symbol) |
| ExponentExpression(a, b) | EXP | a\hat{ }b |
| FunctionApplication(f, x1, . . . , xn) | FUNC | the function f applied to argument(s) |
| | | x1, . . . , xn |
| FractionExpression(a, b) | FRAC | a/b, where a and b are integers |
| MixedNumberExpression(a, b, c) | MIXED | whole part a, fractional part b/c |
| NegativeExpression(n) | NEG | − n |
| NumberExpression(n) | NUM | the number n (could be integer or decimal) |
| PolyExpression(p1, p2, . . . , pn) | POLY | p1 + p2 + . . . + pn |
| RadicalExpression(a, b) | RAD | the b^{th} root of a |
| RatioExpression(a, b) | RATIO | a/b, where a and b are arbitrary |
| SignedExpression(a, x) | SIGNED | x, with a sign as indicated by a, i.e., |
| | | negative or plus/minus |
| TermExpression(t1, t2, . . . , tn) | TERM | t1 * t2 * . . . * tn |
| VariableExpression(x) | VAR | the variable x |

To illustrate step 406, NLG 226 visits node 532 (of type NumberExpression) during traversal of tree 500. NLG 226 produces natural language text for node 532 that is based on the type of the node and that describes the number that corresponds to the node. Specifically, NLG 226 applies a set of rules from language rule database 240, e.g., the rules included in Appendix A, to determine what text to output for this particular node type. The resulting text describes the mathematical concept, in reasonably accurate natural language, represented by syntax tree nodes. Though the result may or may not be absolutely precise natural language, the resulting text describes the mathematical concept in such a manner that a speaker of the natural language that understands mathematical expressions would understand the resulting text to mean the mathematical concept represented by the corresponding node. Embodiments of the rules in language rule database 240 may include other node types than the types listed in the examples herein, and other implementations of the example node types (including additional or alternative contextual language, which is described in further detail below).

NLG 226 applies the rules for NumberExpression in Appendix A, because the type of node 532 is “NumberExpression”. Based on these rules, NLG 226 outputs the whole number part of the number as a cardinal integer. To output the cardinal integer, NLG 226 identifies the applicable case for node 532 within the rules for outputting integers. Specifically, NLG 226 identifies that the number is non-zero and has a value less than ‘1000’, and therefore identifies the “Non-Zero Numbers Less Than 1000 Case” as appropriate for outputting natural language to represent node 532. According to the rules in the identified case, NLG 226 outputs the appropriate value from DIGIT_CARDINALS, which is “three”.

The text that NLG 226 outputs for node 532 describes the mathematical expression corresponding to the node because a speaker of the natural language would understand the outputted text, “three”, to mean the number ‘3’, as represented by child node 534 of node 532. More details about generating natural language for numbers are included below.

Natural language produced for a particular syntax tree node may also be based, at least in part, on a context of the particular node. For example, Appendix A includes three special contexts that may be used while producing natural language for a mathematical expression: TERM, EXPONENT, and NUMERATOR. Appendix A also refers to a “non-standard context”, which, is any one of the TERM, EXPONENT, and NUMERATOR contexts. At times, when one of these contexts is applicable to a syntax tree node, the context causes NLG 226 to output additional context text that NLG 226 would not output in the absence of the applicable context. As such, applying contexts to syntax tree nodes facilitates insertion of natural language phrasing into portions of the natural language text representation of a mathematical expression to make the resulting text more intelligible to a natural language speaker than the text would be without the context-based natural language phrasing.

For example, according to Appendix A, when NLG 226 visits a PolyExpression-type node to which has been applied any of the three contexts, NLG 226 first outputs “the quantity”, which is context text that facilitates understanding of the PolyExpression concept in the language for a larger mathematical expression.

Context text for a syntax tree node may be output before, amidst, or after the natural language communicating the particular concept represented by the syntax tree node itself. To further illustrate, if the special context applied to a PolyExpression-type node is a NUMERATOR context, NLG 226 appends “all” to the output string after the natural language that NLG 226 generates to communicate the concept of the PolyExpression-type node itself. To illustrate a benefit of such context text, “1/(2+3)” becomes “one over the quantity two plus three” but “(1+2+3)/(4+5)” is transformed to “the quantity one plus two plus three all over the quantity four plus five”. In the absence of a special context, when visiting a PolyExpression-type node, NLG 226 simply outputs the natural language for the PolyExpression-type node without additional context text.

As a further example, when NLG 226 visits a RatioExpression-type node to which has been applied an EXPONENT context, NLG 226 first outputs “the quantity”, which is context text that facilitates understanding of the natural language for the RatioExpression-type node. In the absence of a context, when visiting a RatioExpression-type node, NLG 226 simply outputs the natural language for the RatioExpression-type node without additional context text.

### Ordering the Natural Language for Nodes of a Syntax Tree into a Natural Language Output String

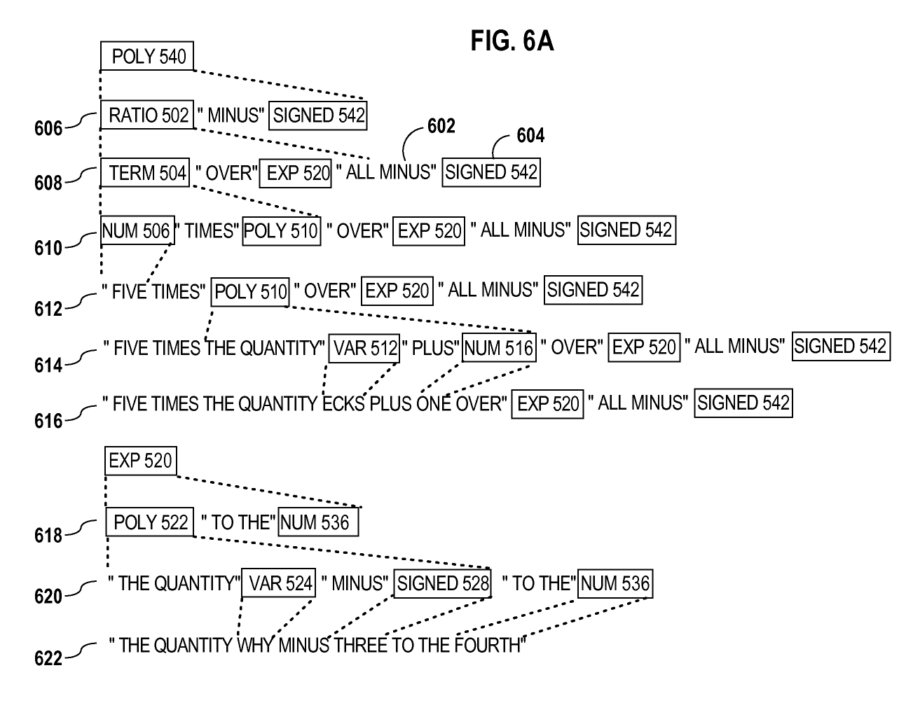

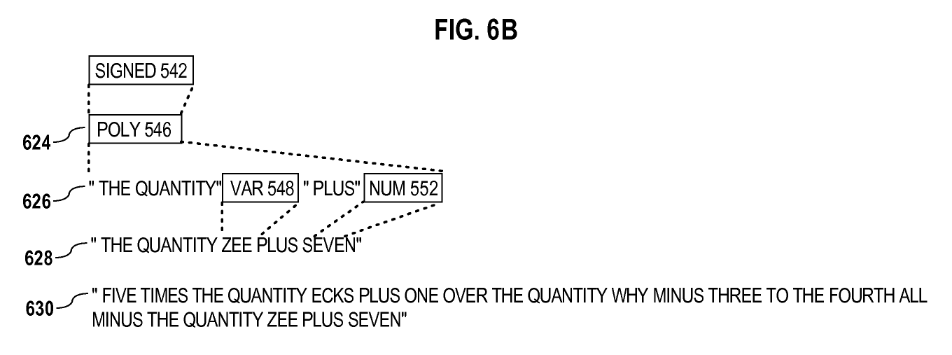

At step 408, the texts generated for the plurality of nodes are combined in an order that is based, at least in part, on the structure of the tree, to create an output string that is a natural language description of the mathematical expression. For example, NLG 226 outputs natural language for nodes of syntax tree 500 based on the rules of Appendix A, and combines the resulting text based, at least in part, on the structure of tree 500, as depicted below in connection with FIGS. 6A-6B.

FIGS. 6A-6B collectively depict a non-limiting example of NLG 226 generating a natural language output text string to represent mathematical expression 100 by visiting the nodes of tree 500 and outputting natural language text based on the exemplary rules of Appendix A. Specifically, FIGS. 6A-6B depicts a series of outputs 606-630 that include both (a) natural language text that NLG 226 has identified for particular nodes of the tree (such as text item 602); and (b) placeholders for nodes of tree 500 that are yet to be visited, which are enclosed in boxes (such as tree node item 604). The generated text and placeholders are located, within each output of FIGS. 6A-6B, based on the structure of tree 500.

Outputs 606-630 are depicted as such for ease of explanation. However, NLG 226 may visit the nodes of a syntax tree in any order, and may track outputted natural language in any manner, within embodiments. Thus, the ordering of outputs 606-630 and the explanation of processing the outputs 606-630 is a non-limiting example embodiment.

To create natural language text based on syntax tree 500, NLG 226 visits the PolyExpression-type root node of tree 500 (i.e., node 540). A special context is not applicable to node 540 because the node is the first to be visited. As depicted at output 606 of FIG. 6A, and based on the rules of Appendix A for PolyExpression-type nodes, NLG 226 outputs natural language text for the first child node of node 540 (i.e., node 502) and natural language text for the second child node of node 540 (i.e., node 542) with an appropriate sign word between them based on the sign of node 542. For the appropriate sign word, NLG 226 determines that node 544 indicates that the sign of node 542 is negative. Therefore, NLG 226 outputs “minus” between the natural language text for nodes 502 and 542. According to the rules for PolyExpression-type nodes, a TERM context is applied to node 502, since it is a RatioExpression that is not the last expression in the PolyExpression, and no context is applied to node 542.

NLG 226 visits node 502, which is of type RatioExpression. According to the rules for RatioExpression in Appendix A and as depicted at output 608 of FIG. 6A, NLG 226 outputs natural language text for the first node of node 502 (i.e., node 504) under a NUMERATOR context, outputs “over”, and outputs natural language text for the second node of node 502 (i.e., node 520). Since node 502 is under a TERM context, NLG 226 further outputs “all”.

Text item 602 (i.e., “minus”) is maintained in output 608 immediately subsequent to the output for node 502 because text item 602 is in its proper place relative to the other output items in output 608 (and in subsequent outputs) based on the structure of syntax tree 500. Also, since item 604 (i.e., the placeholder for node 542) is yet to be visited, item 604 is also maintained in its proper place subsequent to text item 602 within the depiction of output 608 (and in subsequent outputs) until NLG 226 visits the node.

NLG 226 visits node 504 (which is of type TermExpression) under a NUMERATOR context, the output for which is depicted at output 610. Specifically, based on the rules for TermExpressions in Appendix A, NLG 226 outputs the natural language text for the first child of node 504 (i.e., node 506) under a TERM context. As indicated in the rules, NLG 226 determines that the first child of node 504 is a number (e.g., of type NumberExpression), but the second child of node 504 (i.e., node 510) is not a variable, and thus NLG 226 outputs “times” before outputting the natural language text for the second child of node 504 (i.e., node 510), also under a TERM context. If the second child of node 504 had been a variable (e.g., of type VariableExpression), then NLG 226 would have outputted natural language text for the child nodes of node 504 without “times” in between. The NUMERATOR context applied to node 504 has no effect on the natural language outputted for node 504 based on the rules of Appendix A. In other words, no context text is added to the output for node 504 because of the special context applied to node 504.

NLG 226 visits node 506, which is of type NumberExpression, the output for which is depicted at output 612. The number for node 506 (indicated in child node 508) is ‘5’, which is a whole number and is outputted as a cardinal integer, according to the rules for NumberExpression in Appendix A. Because the cardinal number is non-zero and less than 1000, NLG 226 outputs the appropriate natural language value from DIGIT_CARDINALS, which is “five”. More information about outputting numbers is included below. According to the rules of Appendix A, the TERM context for node 506 has no effect on the output for node 506.

NLG 226 visits PolyExpression-type node 510 and applies the rules for PolyExpressions in Appendix A. Specifically, as depicted at output 614, NLG 226 first outputs “the quantity” because of the special TERM context applied to node 510. NLG 226 then outputs the natural language text for the first child of node 510 (i.e., node 512), then an operator word based on the sign of the next child of node 510 (i.e., node 516). Node 516 is a NumberExpression, the sign of which is defined to be positive, and thus NLG 226 outputs “plus”. NLG 226 then outputs the natural language text for node 516.

NLG 226 visits node 512 of type VariableExpression, the output of which is represented at output 616. Based on the rules in Appendix A for VariableExpressions, NLG 226 outputs the natural language representation of the variable at child node 514. According to one embodiment, NLG 226 outputs “X”. According to another embodiment depicted in output 616, NLG 226 outputs a phonetically-spelled representation of the single alphabetical character of the variable (‘X’)—such as “ecks”—to facilitate proper automatic pronunciation of the variable, e.g., by TTS converter service 218 at client device 210 (FIG. 2).

NLG 226 visits node 516, of type NumberExpression, the output of which is also depicted at output 616. Based on the rules of Appendix A for NumberExpressions (as explained above), NLG 226 outputs “one” for node 516, as indicated by child node 518.

NLG 226 visits node 520, which is the second child node of node 502. To simplify the depiction of the output of NLG 226 for node 520, outputs 618-622 do not depict natural language and tree node placeholders surrounding the output for node 520 and its child nodes. In other words, outputs 618-622 treat the output for node 520 in isolation from its context in the overall output for expression 100. The resulting output for node 520 is depicted in its proper place in the final output string for expression 100 at output 630 of FIG. 6B.

The output for the visit of NLG 226 to ExponentExpression-type node 520 is depicted by output 618 of FIG. 6A. According to the rules in Appendix A for ExponentExpressions, NLG 226 determines whether the first child of node 520 (i.e., node 522) is a FunctionApplication-type node. Since node 522 is not a FunctionApplication-type node, NLG 226 outputs the natural language for node 522 under the TERM context. Because the child node of node 520, which represents the exponent (i.e., node 536), does not represent a ‘2’ or a ‘3’, NLG 226 outputs “to the” and followed by the natural language for node 536 under the EXPONENT context. If node 536 had represented ‘2’ or ‘3’, NLG 226 would have output “squared” or “cubed”, respectively, instead of “to the” and the natural language for node 536.

NLG 226 visits node 522 and applies the rules from Appendix A for PolyExpressions, the results of which are depicted at output 620. Because node 522 is under the TERM context, NLG 226 outputs “the quantity” and then outputs natural language for each child node of PolyExpression node 522 with an appropriate sign word between, which is based on the sign of the second child node of node 522 (i.e., node 528). Node 530 indicates that the sign of node 528 is negative, and thus, NLG 226 outputs “minus” between the natural language text for node 524 and node 528.

NLG 226 visits VariableExpression-type node 524, the output for which is depicted at output 622. According to the present example and the rules at Appendix A for VariableExpressions, NLG 226 outputs “why” for node 524 (which is a phonetic spelling of the variable character ‘Y’ indicated in child node 526).

NLG 226 visits SignedExpression-type node 528, the output for which is also depicted at output 622. NLG 226 determines that a signed word has already been output (in connection with outputting parent node 522, and therefore does not output a sign word. NLG 226 then outputs the second child node of node 528 (i.e., node 532) under a TERM context because the SignedExpression is not positive. A placeholder for node 532 is not depicted in output 622. NLG 226 visits node 532, and applies the rules for NumberExpressions to node 532, which results in NLG 226 outputting “three” for node 532 based on child node 534 representing the number ‘3’. The TERM context does not add any context text to the output for node 532. According to the example embodiment of Appendix A, NLG 226 at times outputs “negative” immediately before the number value of a SignedExpression, e.g., when a negative SignedExpression is the first term of a PolyExpression, or when the SignedExpression is not part of a PolyExpression.

NLG 226 visits NumberExpression-type node 536 under the EXPONENT context, the results of which are also depicted at output 622. According to the rules in Appendix A for NumberExpressions and because the EXPONENT context is applied to node 536, the number is output as an ordinal. Therefore, NLG 226 outputs the appropriate value, corresponding to the value of node 538 (‘4’), from DIGIT_ORDINALS, which is “fourth”.

FIG. 6B depicts outputs 624-628 of NLG 226 for expression 100, in which the processing of SignedExpression node 542 is depicted without the natural language that NLG has output for the other nodes of tree 500 to simplify the depiction of the output. The resulting output for node 542 is depicted in its proper place in the final output string for expression 100 at output 630 of FIG. 6B.

NLG 226 visits SignedExpression-type node 542 and applies the rules in Appendix A for SignedExpressions, as depicted in output 624. Since a sign word for SignedExpression node 542 has already been output in connection with processing the parent PolyExpression node 540, NLG 226 outputs the natural language for the child node of node 542 (i.e., node 546) without an additional sign word. Because SignedExpression node 542 is not positive, a TERM context is applied to node 546.

NLG 226 visits PolyExpression node 546, and applies the rules in Appendix A for PolyExpressions, the output for which is depicted at output 626. Because the TERM context (a non-standard context) is applied to node 546, NLG 226 first outputs “the quantity”. NLG 226 then outputs natural language for each child node of PolyExpression node 546 with an appropriate sign word inserted between the natural language for the child nodes. Specifically, as depicted in output 626, NLG 226 outputs natural language for VariableExpression-type node 548 and natural language for NumberExpression node 553 with the sign word “plus” between, since a NumberExpression is defined to be positive.

NLG 226 visits VariableExpression-type node 548, and applies the rules in Appendix A for VariableExpressions, as depicted in output 628. Specifically, NLG 226 outputs “zee” for node 548, which is a phonetic spelling of the variable character ‘Z’ represented at child node 550. NLG 226 also visits NumberExpression-type node 552, and applies the rules in Appendix A for NumberExpressions, which is also depicted in output 628. Specifically, NLG 226 outputs “seven” for node 552 to represent the number ‘7’ at child node 554.

Thus, as depicted at final output 630 of FIG. 6B, NLG 226 outputs the following natural language for mathematical expression 100 based on syntax tree 500: “FIVE TIMES THE QUANTITY ECKS PLUS ONE OVER THE QUANTITY WHY MINUS THREE TO THE FOURTH ALL MINUS THE QUANTITY ZEE PLUS SEVEN”.

### Outputting the Natural Language

At step 410 of flowchart 400 (FIG. 4), the output string is outputted. For example, NLG 226 sends information for the natural language generated for expression 100 (e.g., depicted in output 630) to math converter client 212. According to one embodiment, math converter client 212 outputs the natural language by causing TTS converter service 218 to convert the natural language for expression 100 to speech. According to an embodiment, TTS converter service 218 is configured to output audio, for the speech derived from the natural language for expression 100, via audio capabilities of client device 210. Field 342 of GUI 300 (FIG. 3) displays representations of voices, such as Speech API (SAPI) voices, that are installed on client device 210. A user of client device 210 may select one of the installed voices to choose the style of speech being created by TTS converter service 218.

According to another embodiment, math converter client 212 outputs the natural language for expression 100 by displaying text, such as ASCII text, which represents the generated natural language, in a graphical user interface such as GUI 300 of FIG. 3. In the example of GUI 300, field 332 displays text 330 that represents natural language created by NLG 226 to communicate expressions 310/320. In an embodiment, math converter client 212 outputs the natural language for expression 100 and also displays a structured mathematical representation of expression 100, e.g., as an image. According to yet another embodiment, math converter client 212 causes the natural language generated for expression 100 to be both (a) displayed as text, and (b) converted to speech by TTS converter service 218.

### Natural Language Text for Number Expressions

Special care is taken for processing numbers, as there can be numerous special cases. For example, the American English rules governing natural language for communicating ones and tens places are irregular. (For example, natural language for ‘107’ may be “one hundred seven” or “one hundred and seven”). Also, there are repeating patterns every three powers of ten that can be exploited to simplify the creation of natural language for larger numbers. (For example, with grouping, natural language for ‘123456’ is “one hundred twenty three thousand, four hundred fifty six”.) Numbers with digits after a decimal point are generally spoken digit by digit, even if the whole number portion of the number is read with the digits grouped. (For example, natural language for ‘123456.78’ is “one hundred twenty three thousand, four hundred fifty six point seven eight”.) Furthermore, the rules in Appendix A direct natural language for numbers not after a decimal point to be grouped, but embodiments include natural language for numbers to communicate each number separately without grouping. (For example, without grouping, natural language for ‘123456.78’ is “one two three four five six point seven eight” or “the number one two three four five six point seven eight”.)

As indicated above in connection with generating natural language for mathematical expression 100, NLG 226 applies the rules in Appendix A to create natural language for numbers. To illustrate application of these rules more thoroughly, the examples below illustrate developing natural language for the following numbers based on the rules in Appendix A: ‘0’; ‘107’; ‘1,402,000’; ‘½’; ‘5/1’; and ‘5/25’. Some examples develop natural language for the cardinal and the ordinal versions of the number, respectively (as indicated).

### Natural Language for ‘0’

Since the number has the value of ‘0’, NLG 226 applies the “Zero Case” rules in the Integer Rule Set of Appendix A. Accordingly, NLG 226 outputs “zero” (cardinal) or “zeroth” (ordinal). The number ‘0’ does not trigger NLG 226 to apply the rules for numbers less than ‘1000’ because it is a special case, and the rules require NLG 226 to “stop” once a Zero Case has been identified and outputted as such.

### Natural Language for ‘107’ (Cardinal)

Because ‘107’ is non-zero and less than ‘1000’, NLG 226 applies the rules in the “Numbers Less Than 1000 Case” in the Integer Rule Set of Appendix A. According to these rules, NLG 226 first addresses the hundreds place digit of ‘107’, which is ‘1’. NLG 226 outputs the appropriate digit from DIGIT_CARDINALS followed by “hundred”. As such, NLG 226 outputs “one hundred”.

NLG 226 then addresses the tens place digit of ‘107’, which is ‘0’. According to the rules, the tens-place digit is only output if it is non-zero. Therefore, NLG 226 does not output anything for the tens digit.

NLG 226 then addresses the ones place digit of ‘107’, which is ‘7’. According to the rules, NLG 226 outputs the appropriate value from DIGIT_CARDINALS, which is “seven”.

Thus, the output for ‘107’ as a cardinal number is “one hundred seven”.

### Natural Language for ‘107’ (Ordinal)

The output for ‘107’ as an ordinal is similar to the output of ‘107’ as a cardinal, except that instead of outputting a value from DIGIT_CARDINALS for the ones place digit, NLG 226 outputs a value from DIGIT_ORDINALS. This change produces “seventh” instead of “seven” for the ones place digit.

Thus, the output for ‘107’ as an ordinal number is “one hundred seventh”.

### Natural Language for ‘1,402,000’ (Cardinal)

Because ‘1,402,000’ is greater than ‘1000’, NLG 226 applies the rules in Appendix A for the “Numbers 1000 or Greater Case” to produce natural language for this number. Specifically, NLG 226 first breaks the number up into three-digit groups, where the most significant group may have less than three digits: ‘1’ (millions), ‘402’ (thousands), and ‘000’ (hundreds).

For the most significant group, NLG 226 outputs the number (‘1’) based on the rules for the “Non-Zero Numbers Less Than 1000 Case”, which produces the output “one”. Since the number is not an ordinal, NLG 226 outputs the relevant value from BIG_CARDINALS, which is “million”.

For the next most significant group, NLG 226 outputs the numbers (‘402’) based on the rules for the “Non-Zero Numbers Less Than 1000 Case”, which produces the output “four hundred two”. Again, because the number is not an ordinal, NLG 226 then outputs the relevant value from BIG_CARDINALS, which is “thousand”. The rest of the digits are all zero, so NLG 226 stops, or in other words, does not output any natural language for the least significant number group. Therefore, the output for the cardinal number ‘1,402,000’ is “one million four hundred two thousand”.

### Natural Language for ‘1,402,000’ (Ordinal)

The output for ‘1,402,000’ as an ordinal number is similar to the output of the number as a cardinal. The difference is, in response to NLG 226 determining that the number is an ordinal and the digits less significant than the thousands group of numbers are all zero, NLG 226 outputs the appropriate value from BIG_ORDINALS, which is “thousandth” instead of “thousand”. Thus, the output for ‘1,402,000’ as an ordinal number is “one million four hundred two thousandth”.

### Natural Language for ‘½’

NLG 226 applies the rules in Appendix A to create a natural language representation for fractions. A fraction would be represented in a syntax tree by a FractionExpression node with a first child node representing the numerator and a second child node representing the denominator. To produce natural language for a FractionExpression node, NLG 226 applies the rules in Appendix A for FractionExpressions.

To illustrate producing natural language for the fraction ‘½’, NLG 226 first outputs the numerator, ‘1’, as an integer. According to the rules in Appendix A for outputting integers, NLG 226 outputs “one”. NLG 226 then determines that the denominator equals ‘2’—which triggers a special case—and NLG 226 outputs “half” (singular since the numerator equals one). Thus, NLG 226 outputs “one half” for ‘½’.

### Natural Language for ‘5/1’

As a further example, for ‘5/1’, and according to the rules of Appendix A, NLG 226 first outputs the numerator, ‘5’, as an integer (“five”). Then NLG 226 outputs the denominator, ‘1’, as an ordinal integer. However, according to the “Denominator Case” in the Integer Rule Set in Appendix A, if the denominator has a value of ‘1’, then NLG 226 stops without outputting any natural language for the denominator. Thus, the output for ‘5/1’ is “five”. According to another embodiment, NLG 226 outputs “five over one” or “five ones” as the natural language for ‘5/1’.

### Natural Language for ‘5/25’

As yet a further example, for ‘5/25’, and according to the rules of Appendix A, NLG 226 first outputs the numerator, ‘5’, as an integer (“five”). Then NLG 226 outputs the denominator as an ordinal integer. According to the “Denominator Case” in the Integer Rule Set in Appendix A, since the denominator does not equal ‘1’, NLG 226 continues in the rules to output the denominator as an ordinal integer. NLG 226 applies the rules for the “Non-Zero Numbers Less Than 1000 Case” in Appendix A to the denominator number, ‘25’. As such, NLG 226 determines that the natural language for ‘25’ as an ordinal is “twenty fifth”. Since the numerator is plural, NLG 226 pluralizes the output for ‘25’ to be “twenty fifths”. Thus, the output for ‘5/25’ is “five twenty fifths”. According to another embodiment, NLG 226 outputs “five over twenty five” as the natural language for ‘5/25’.

### Alternatives and Extensions

According to another embodiment, the rules for PolyExpression and RatioExpression are as follows:

PolyExpression(p1, p2, . . . , pn)
If this is in any non-standard context, start output with “the quantity”.
Output each term p1, p2, . . . , pn; in between each term, enter the appropriate sign word based on their sign: “plus”; “minus”; or “plus or minus”.
If NUMERATOR context is applied, output “all”.

RatioExpression(A,B)
If we're in EXPONENT context, output “the quantity”.
Output A in NUMERATOR context.
Output “over”.
Output B under the TERM context.

Applying the above versions of the rules for PolyExpression and RatioExpression, (with all other rules as is listed in Appendix A), NLG 226 outputs the following natural language for mathematical expression 100 based on syntax tree 500: “FIVE TIMES THE QUANTITY ECKS PLUS ONE OVER THE QUANTITY WHY MINUS THREE TO THE FOURTH MINUS THE QUANTITY ZEE PLUS SEVEN”.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

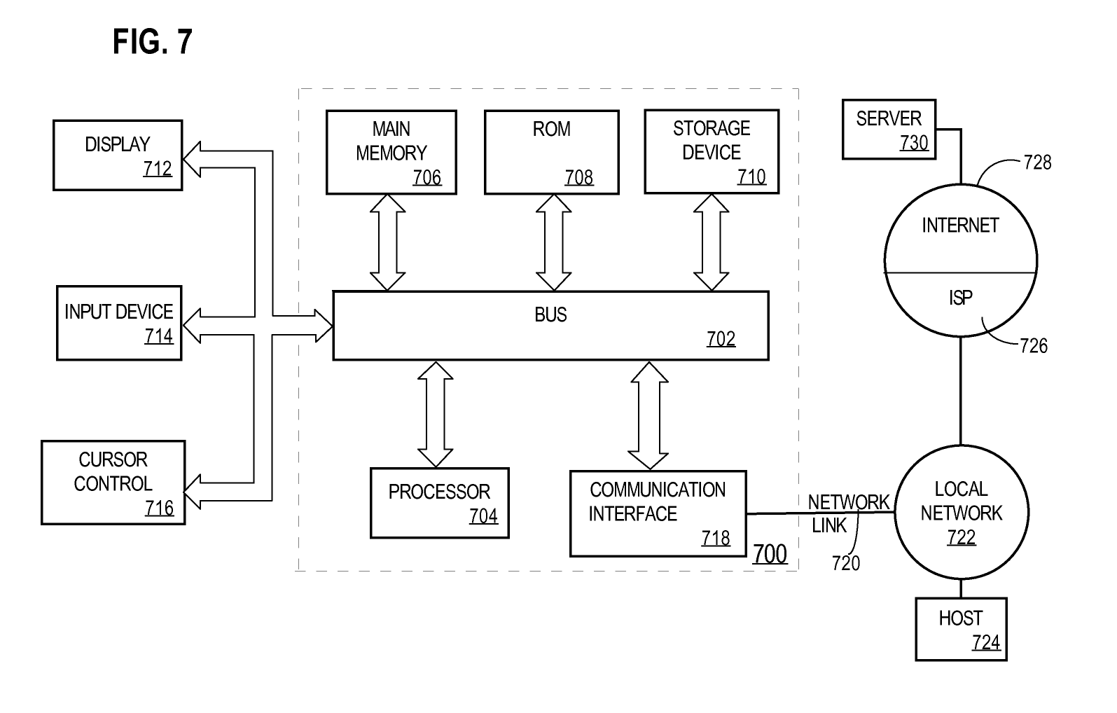

For example, FIG. 7 is a block diagram that depletes a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### Appendix A: Natural Language Rules

### AbsoluteValueExpression(X):

Output “the absolute value of”, followed by the output for X under the TERM context.

### DivisionSymbol(A,B)

Output A, then “divided by”, then output B.

### ExponentExpression(A,B):

If A is a FunctionApplication, then:
   output its function,
   followed by the exponent (described below),
   followed by “of”, and
   followed by A's one or more arguments.
Otherwise, output A under the TERM context.
Output B as an exponent as follows:
   If B is two, then output “squared”.
   If B is three, then output “cubed”.
   Otherwise, output “to the” followed by the result of processing B in the EXPONENT context.

### FunctionApplication(F, X₁, . . . , Xₙ)

Output F's name (could be as simple as “f”, or be an actual function: “sine”, “cosine”, “ceiling”, etc.—the FunctionApplication includes the function's name), followed by “of”. For each individual argument X₁, . . . , X₁, output it in the TERM context; separate the outputs by “and”.
   FractionExpression(A,B) where A and B are both integers.
Output A as an integer according to the rules for processing integers below.
If B is 2, then output “half” or “halves” depending on whether A equals “1”.
   Otherwise, output B as an ordinal integer (again, see integer rules), pluralized if A does not equal “1”.

### MixedNumberExpression(A,B,C)

Output A as an integer. Follow this with B/C output as if it was the following node: FractionExpression(B,C).

### NumberExpression(N)

If under the EXPONENT context or if N is to be output as an ordinal, output N as an ordinal integer according to the rules for outputting integers below.
Else, output the whole number part of N as a cardinal integer according to the rules for outputting integers below.
If there is a decimal part, output “point”, and output each digit after the decimal, with spaces in between.
   PolyExpression(p1, p2, . . . , pn)
If this is in any non-standard context, start output with “the quantity”.
Output each term p1, p2, . . . , pn (if any term other than pn is a RatioExpression, apply the TERM context to outputting the term); in between each term, enter the appropriate sign word based on their sign: “plus”; “minus”; or “plus or minus”.
If NUMERATOR context is applied, output “all”.

### RadicalExpression(A, B)

Output “the”.
If B equals 2, output “square”.
If B equals 3, output “cube”.
If B equals some other integer, output the ordinal form of B.
Output “root of”.
Output A, in EXPONENT context.

### RatioExpression(A,B)

If we're in EXPONENT context, output “the quantity”.
Output A in NUMERATOR context.
Output “over”.
Output B.
If we're in TERM context, output “all”.
   SignedExpression(X, sign)
Unless a signed word has already been output for X, output the appropriate sign word for X: “plus or minus” or “negative” as appropriate, or nothing if positive.
Output X under a TERM context, unless the signed expression was positive.
   TermExpression(t1, t2, . . . , tn
If in EXPONENT context, output “quantity”.
For each item t1, t2, . . . , tn, output it under a TERM context. Between them, output “times”, EXCEPT in the case where the current item is a variable and the one before it is a number; (e.g. “three x” instead of “three times x”).

### VariableExpression(X)

Output the string representation of X. This could be either just the letter (“x”,“y”, “z”), or a phonetic representation if that is more useful in this context (“ecks”, “why”, “zee”).
   INTEGER RULE SET (both cardinals and ordinals):

### Integer Natural Language Sets:

DIGIT_CARDINALS: zero, one, two, three, . . . .
DIGIT_ORDINALS: zeroth, first, second, third, . . . .
BIG_CARDINALS: thousand, million, billion, . . . .
BIG_ORDINALS: thousandth, millionth, billionth, . . . .
TEENS_CARDINALS: ten, eleven, twelve, . . . .
TEENS_ORDINALS: tenth, eleventh, twelfth, . . . .
TENS_CARDINALS: ten, twenty, thirty, forty, . . . .
TENS_ORDINALS: tenth, twentieth, thirtieth, fortieth, . . . .
   Zero Case: If this number has a value of “0”, then:
Output “zero” (or “zeroth” for the ordinal) and stop.
   Denominator Case: If this number is being used as the denominator of a fraction, then:
If this number has a value of “1”, then stop.
   Numbers 1000 or Greater Case: If this number has a value of “1000” or greater, then:
Break the number up into three digit groups, where the most significant group might have less than three digits.
For each non-zero group except the hundreds group:
   Ignoring any leading zeros, output the group as a cardinal number according to the “Non-Zero Numbers Less Than 1000 Case”.
   If the number is an Ordinal and the digits that are less significant than this group are all zero, then output the appropriate value from BIG_ORDINALS.
   Otherwise, output the relevant value from BIG_CARDINALS.
   If the digits of subsequent groups are all zero, stop.
For the hundreds group, output as specified below for the “Non-Zero Numbers Less Than 1000 Case”.
   Non-Zero Numbers Less Than 1000 Case: If this number has a value less than “1000”, then:
If there is a hundreds place digit and it is non-zero, then:
   Output that digit (from DIGIT_CARDINALS), followed by “hundred”.
   If this is an ordinal and the following digits are zero, output “th”.
If there is a tens place digit, and it is non-zero, then:
   If the tens place digit is “1”, then output the appropriate value from TEENS_CARDINALS if a cardinal, or TEENS_ORDINALS if an ordinal and stop.
   Else:
      If this is an ordinal, output the appropriate case from TENS_ORDINALS.
      Otherwise, output the appropriate digit from TENS_CARDINALS.
If the ones place digit is non-zero, then:
   Output the appropriate value from DIGIT_CARDINALS if a cardinal, or DIGIT_ORDINALS if an ordinal.

What is claimed is:

1. A method comprising:
parsing characters that represent a mathematical expression into a tree that represents the structure of the mathematical expression;
wherein the tree includes a plurality of nodes;
performing a traversal of the tree that visits each node of the plurality of nodes;
while performing the traversal of the tree, generating text for each node, of the plurality of nodes, in response to visiting the node;
wherein generating text for each node includes generating text for a particular node based, at least in part, on a type of the particular node;
wherein the generated text for the particular node comprises natural language text that describes a portion of the mathematical expression that corresponds to the particular node;
combining the texts generated for the plurality of nodes, in an order that is based, at least in part, on the structure of the tree, to create an output string that is a natural language description of the mathematical expression; and
outputting the output string;
wherein the method is performed by one or more computing devices.

2. The method of claim 1, wherein generating text for each node of the plurality of nodes includes generating text for a certain node of the plurality of nodes based, at least in part, on a context of the certain node.

3. The method of claim 2, wherein the context of the certain node is based, at least in part, on the position of the certain node within said tree.

4. The method of claim 2, wherein the context of the certain node is based, at least in part, on a parent node of the certain node.

5. The method of claim 2, wherein generating text for said certain node comprises including context text, in the generated text for said certain node, that is based, at least in part, on the context of said certain node.

6. The method of claim 1, wherein:
said particular node includes a representation of a single alphabetical character; and
the generated text for said particular node includes a phonetically-spelled representation of said single alphabetical character.

7. The method of claim 1, wherein outputting the output string comprises making the output string available to a text-to-speech mechanism.

8. The method of claim 1, further comprising:
receiving said characters that represent the mathematical expression at a graphical user interface;
wherein outputting the output string comprises displaying the output string in the graphical user interface.

9. The method of claim 1, further comprising:
receiving an ordered set of characters that includes both (a) said characters that represent the mathematical expression (“mathematical characters”), and (b) characters that do not represent mathematical expression;
identifying said mathematical characters based, at least in part, on a first tag that immediately precedes said mathematical characters and a second tag that immediately follows said mathematical characters in the ordered set of characters.

10. A non-transitory computer-readable medium that stores instructions which, when executed by one or more processors, cause the steps of:
parsing characters that represent a mathematical expression into a tree that represents the structure of the mathematical expression;
wherein the tree includes a plurality of nodes;
performing a traversal of the tree that visits each node of the plurality of nodes;
while performing the traversal of the tree, generating text for each node, of the plurality of nodes, in response to visiting the node;
wherein generating text for each node includes generating text for a particular node based, at least in part, on a type of the particular node;
wherein the generated text for the particular node comprises natural language text that describes a portion of the mathematical expression that corresponds to the particular node;
combining the texts generated for the plurality of nodes, in an order that is based, at least in part, on the structure of the tree, to create an output string that is a natural language description of the mathematical expression; and
outputting the output string.

11. The non-transitory computer-readable medium of claim 10, wherein generating text for each node of the plurality of nodes includes generating text for a certain node of the plurality of nodes based, at least in part, on a context of the certain node.

12. The non-transitory computer-readable medium of claim 11, wherein the context of the certain node is based, at least in part, on the position of the certain node within said tree.

13. The non-transitory computer-readable medium of claim 11, wherein the context of the certain node is based, at least in part, on a parent node of the certain node.

14. The non-transitory computer-readable medium of claim 11, wherein generating text for said certain node comprises including context text, in the generated text for said certain node, that is based, at least in part, on the context of said certain node.

15. The non-transitory computer-readable medium of claim 10, wherein:
said particular node includes a representation of a single alphabetical character; and
the generated text for said particular node includes a phonetically-spelled representation of said single alphabetical character.

16. The non-transitory computer-readable medium of claim 10, wherein outputting the output string comprises making the output string available to a text-to-speech mechanism.

17. The non-transitory computer-readable medium of claim 10, further comprising instructions which, when executed by the one or more processors, cause the steps of:
receiving said characters that represent the mathematical expression at a graphical user interface;
wherein outputting the output string comprises displaying the output string in the graphical user interface.

18. The non-transitory computer-readable medium of claim 10, further comprising instructions which, when executed by the one or more processors, cause the steps of:
receiving an ordered set of characters that includes both (a) said characters that represent the mathematical expression (“mathematical characters”), and (b) characters that do not represent mathematical expression;
identifying said mathematical characters based, at least in part, on a first tag that immediately precedes said mathematical characters and a second tag that immediately follows said mathematical characters in the ordered set of characters.
